(19) United States
(12) Patent Application Publication
(10) Pub. No.: US 2012/0240434 A1
(43) Pub. Date: Sep. 27, 2012

(54) DISPLAY DEVICE

(75) Inventor: Daisuke NEZU, Tokyo (JP)

(73) Assignee: SONY CORPORATION, Tokyo (JP)

(21) Appl. No.: 13/491,188

(22) Filed: Jun. 7, 2012

Related U.S. Application Data
(63) Continuation of application No. 12/404,449, filed on Mar. 16, 2009, now abandoned.

(30) Foreign Application Priority Data
Apr. 25, 2008 (JP) 2008-115777

(51) Int. Cl. G09F 13/06; G09F 13/08

(52) U.S. Cl. 40/541

(57) ABSTRACT

The present invention provides a display device, including a display plate having a front surface and a back surface located on a side opposite to the front surface, a transparent material through which a light is transmissive being formed into the plate-like display plate; a printed member disposed on the back surface of the display plate so as to have a display portion formed therein, a first portion through which a light is transmissive and a second portion through which the light is non-transmissive being formed in the printed member by carrying out printing, the display portion being composed of at least one of a symbol, a character and a pattern by the first and second portions; and a radiating portion for radiating a light to the display portion from a portion on a side opposite to the display plate with respect to the printed member.

### CROSS-REFERENCE TO RELATED APPLICATIONS

The present application is a continuation application of and claims the benefit of priority under 35 U.S.C. §120 from U.S. application Ser. No. 12/404,449, filed Mar. 16, 2009, which contains subject matter related to that disclosed in Japanese Priority Patent Application JP 2008-115777, filed in the Japan Patent Office on Apr. 25, 2008, the entire contents of each of which is hereby incorporated by reference.

### BACKGROUND OF THE INVENTION

1. Field of the Invention

The present invention relates to a display device which is advantageous in obtaining a superior exterior appearance while a manufacture cost is reduced.

2. Description of the Related Art

An electronic apparatus is provided with a display device for displaying thereon information on an operation state or manipulation contents in many cases.

Japanese Patent Laid-Open No. Hei 09-64550 proposes this sort of display device in which a display portion for displaying thereon semi-transparent and white characters, symbols or patterns is formed in a panel sheet, and a light is radiated from a back surface of the panel sheet to the display portion to brighten the display portion, thereby displaying the semi-transparent and white characters, symbols or patterns.

### SUMMARY OF THE INVENTION

However, in recent years, there has been proposed a display device in which in order to enhance an exterior appearance property of the display device, for example, a thin metallic film through which a light is adapted to be transmissive or semi-transmissive is vacuum-evaporated on a back surface of a transparent display plate, thereby giving the display plate a metallic-tone exterior appearance, and a display portion for displaying thereon characters or symbols by using a light is disposed on the back surface side of the display plate.

In this display device, when a light emitting portion emits a light, the contents displayed on the display portion are visually recognized by using a light transmitted through the thin metallic film. However, when the light emitting portion emits no light, an outside light is reflected by the thin metallic film, so that the contents displayed on the display portion are not visually recognized.

However, a method of vacuum-evaporating the metallic film on the back surface of the display plate is expensive, and thus there is a limit to a utilization range thereof.

In addition, heretofore, the display portion is directly printed on the display plate, thereby integrating the display portion and the display plate with each other. For this reason, there is a disadvantage that a manufacture cost increases because a plurality kind of display devices in which contents displayed on the display portion are different from one another must be prepared so as to correspond to destinations or specifications, respectively.

The present invention has been made in the light of such circumstances, and it is therefore desirable to provide a display device which is advantageous in obtaining a superior exterior appearance property while a manufacture cost is reduced.

In addition, it is also desirable to provide a display device which is advantageous in suppressing a manufacture cost even when contents displayed on display portions are different from one another.

In order to attain the desire described above, according to an embodiment of the present invention, there is provided a display device including: a display plate having a front surface and a back surface located on a side opposite to the front surface, a transparent material through which a light is transmissive being formed into the plate-like display plate; a printed member disposed on the back surface of the display plate so as to have a display portion formed therein, a first portion through which a light is transmissive and a second portion through which the light is non-transmissive being formed in the printed member by carrying out printing, the display portion being composed of at least one of a symbol, a character and a pattern by the first and second portions; and a radiating portion for radiating a light to the display portion from a portion on a side opposite to the display plate with respect to the printed member. The display plate includes: a pearl ink printed layer through which a light is transmissive or semi-transmissive by printing a pearl ink on the back surface of the display plate; a masking layer through which no light is transmissive, the masking layer formed from a material through which no light is transmissive on a surface of the pearl ink printed layer on a side opposite to a surface of the pearl ink printed layer facing the back surface of the display plate; a light transmissive area through which a light is transmissive, the light transmissive area being composed of a portion of the surface of the masking layer on the opposite side of the pearl ink printed layer, and having no masking layer formed thereon; and a smoke printed layer formed by solid-printing a smoke ink expressing dark semi-transparence on the light transmissive area; in which the display portion. The light transmissive area and the smoke printed layer are disposed in respective portions agreeing with one another in a direction of a thickness of the display plate.

According to another embodiment of the present invention, there is provided a display device including: a display plate having a front surface and a back surface located on a side opposite to the front surface, a transparent material through which a light is transmissive being formed into the plate-like display plate; a printed member disposed on the back surface of the display plate so as to have a display portion formed therein, a first portion through which a light is transmissive and a second portion through which the light is non-transmissive being formed in the printed member by carrying out printing, the display portion being composed of at least one of a symbol, a character and a pattern by the first and second portions; and a radiating portion for radiating a light to the display portion from a portion on a side opposite to the display plate with respect to the printed member. The display plate includes: a first smoke printed layer formed by solid-printing a smoke ink expressing dark semi-transparence on the back surface of the display plate; a masking layer, through which no light is transmissive, made of a material through which no light is transmissive, the masking layer being formed on a surface of the first smoke printed layer on a side opposite to a surface of the first smoke printed layer facing the back surface of the display plate; a light transmissive area through which a light is transmissive, the light transmissive area being composed of a portion of the opposite side surface of the first smoke printed layer, and having no mask layer formed thereon; and a second smoke printed layer formed by solid-printing a smoke ink expressing dark semi-transparence on the light transmissive area; in which the display portion. The first smoke printed layer and the second smoke printed layer are disposed in respective portions agreeing with one another in a direction of a thickness of the display plate and the printed member is formed by printing an ink through which no light is transmissive on a transparent sheet structured separately from the display plate.

According to the preferred embodiments of the present invention, the pearl ink printed layer and the smoke printed layer are printed on the display plate, thereby making it possible to obtain the metallic-tone exterior appearance, which is advantageous in obtaining the superior exterior appearance while the manufacture cost is reduced.

In addition, according to the embodiments of the present invention, since the display plate and the printed member are structured separately from each other, a plurality kind of display devices can be simply structured by carrying out the very simple work that a plurality kind of printed members are previously prepared so as to correspond to the destinations or specifications, respectively, and the printed member selected from the plurality kind of printed members, and the display plate are combined with each other. Therefore, this is advantageous in suppressing the manufacture cost.

### BRIEF DESCRIPTION OF THE DRAWINGS

FIG. 1 is a front view showing an exterior appearance of a television set to which a display device of an embodiment of the present invention is applied;

FIG. 2 is an exploded perspective view of a manipulation section using a display device according to a first embodiment of the present invention;

FIGS. 3A to 3F are respectively top plan views of printed members;

FIG. 4 is an exploded perspective view of a manipulation section using a display device according to a second embodiment of the present invention; and

FIG. 5 is an exploded perspective view of an existing display device.

### DETAILED DESCRIPTION OF THE PREFERRED EMBODIMENTS

The preferred embodiments of the present invention will be described in detail hereinafter with reference to the accompanying drawings.

### First Embodiment

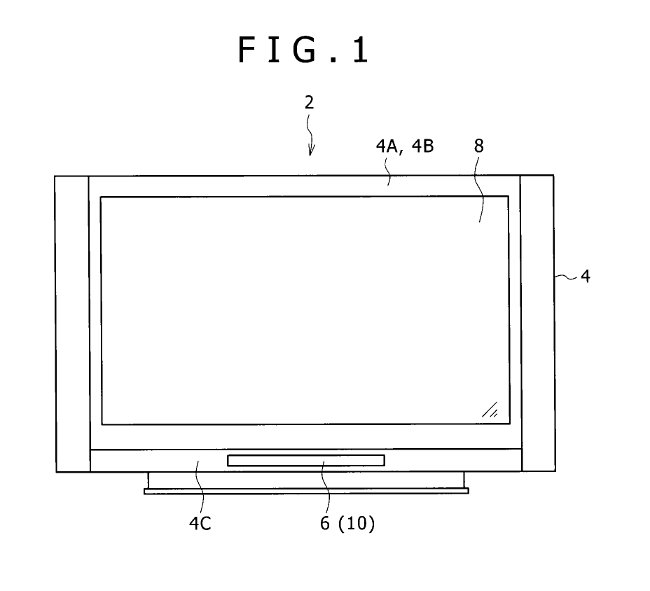

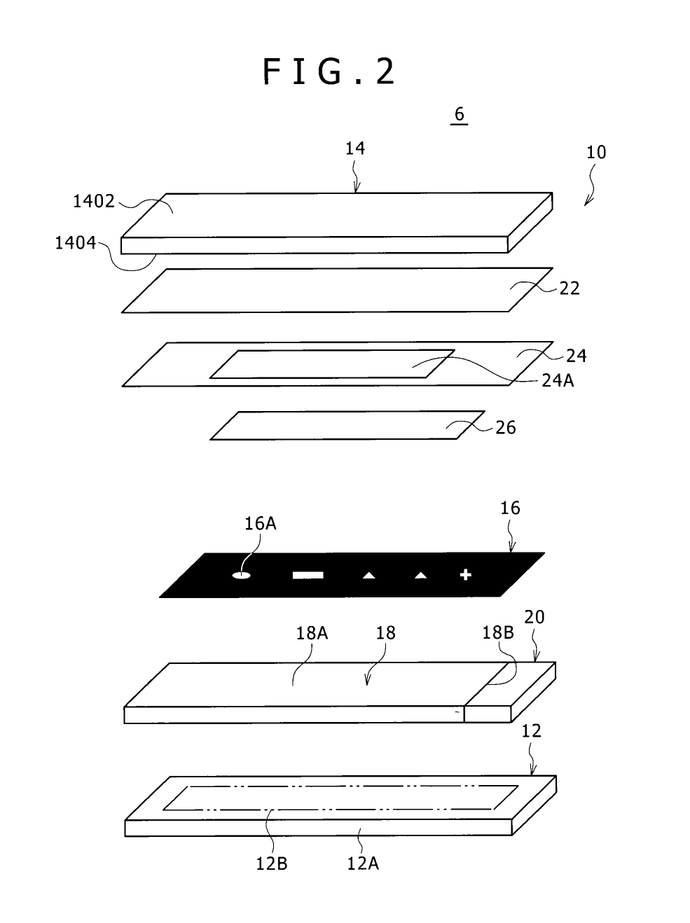

FIG. 1 is a view showing an exterior appearance of a television set 2 to which a display device 10 of an embodiment of the present invention is applied, and FIG. 2 is an exploded perspective view of a manipulation section 6 using a display device 10 according to a first embodiment of the present invention.

The television set 2 has a chassis 4 composing an armoring.

A front surface 4A of the chassis 4 has a rectangular frame-like frame portion 4B, and a display 8 for displaying thereon an image is disposed inside the rectangular frame-like frame portion 4B.

A band plate front panel 4C which extends horizontally and linearly is provided in a lower portion of the front surface 4A of the chassis 4. Also, a manipulation section 6 for manipulating the television set 2 is built into a central portion of the front panel 4C.

As shown in FIG. 2, the manipulation section 6 is composed of the display device 10 according to the embodiment of the present invention, a touch switch 12, and the like.

The display device 10 includes a display plate 14, a printed member 16, a light guiding member 18, a light emitting portion 20, and the like.

The display plate 14 is made of a transparent material through which a light can be transmitted, and has a plate-like shape.

The common knowledge of past various kinds of transparent materials such as an acrylic resin can be adopted as such a transparent material.

One surface in a thickness direction of the display plate 14 is a front surface 1402 facing a front side of the chassis 4, and the other surface of the thickness direction of the display plate 14 is a back surface 1404 facing an inner side of the chassis 4. That is to say, the display plate 14 has the front surface 1402, and the back surface 1404 located on a side opposite to the front surface 1402.

A first smoke printed layer 22, a masking layer 24, and a second smoke printed layer 26 are formed in this order on the back surface 1404 of the display plate 14.

The first smoke printed layer 22 is formed by solid-printing a smoke ink expressing dark semi-transparence over the entire area of the back surface 1404 of the display plate 14.

The first smoke printed layer 22 is formed on the back surface 1404 of the display plate 14, which results in that when as will be described later, a light transmitted through the display portion 16A is radiated from a backward of the display plate 14 to the back surface 1404 of the display plate 14, the light is absorbed in the first smoke ink printed layer 22 to a certain extent, and the remaining light is transmitted through the first smoke ink printed layer 22 to reach the front side from the surface 1402 of the display plate 14, thereby being visually recognized by a user.

On the other hand, when no light is radiated from the backward of the display plate 14 to the back surface 1404 of the display plate 14, even if an outside light is radiated from the front side of the display plate 14 to the front surface 1402 of the display plate 14, the outside light is absorbed by the first smoke ink printed layer 22 because a quantity of outside light is limited.

Therefore, since the first smoke printed layer 22 expresses a dark color, it is impossible to visually recognize any of members, parts or components provided in the backward of the first smoke printed layer 22 through the first smoke printed layer 22.

Such an operation of the first smoke printed layer 22 is offered similarly by the second smoke printed layer 26 which will be described later.

The masking layer 24 is made of a material adapted to transmit no light. Also the masking layer 24 is formed in a part of a surface of the first smoke printed layer 22 on a side opposite to a surface of the first smoke printed layer 22 facing the back surface 1404 of the display plate 14.

In this embodiment, the masking layer 24 is formed by solid-printing a black ink as a material adapted to transmit no light.

In the first embodiment, the masking layer 24 is printed into a rectangular frame-like shape. Therefore, a rectangular light transmissive area 24A, having no mask layer 24 formed therein, which can transmit a light is formed inside the rectangular frame.

In other words, the light transmissive area 24A is composed of a portion of the surface of the mask layer 24 on the side opposite to the surface of the first smoke printed layer 22 facing the back surface 1404, and has no mask layer 24 formed therein.

The second smoke printed layer 26 is formed by solid-printing a smoke ink expressing dark semi-transparence in the light transmissive area 24A.

The printed member 16 is disposed on the back surface 1404 of the display plate 14. Also, the printed member 16 is formed by solid-printing an ink adapted to transmit no light, for example, a black ink on one surface in a thickness direction of a plastic sheet structured separately from the display plate 14.

The plastic sheet is formed to have an outline which is slightly smaller than that of the display plate 14.

A portion adapted to transmit a light and a portion adapted to transmit no light are formed in the printed member 16 by carrying out the printing. Also, one or multiple display portions 16A composed of at least one of a symbol, a character, and a pattern are formed by the two portions.

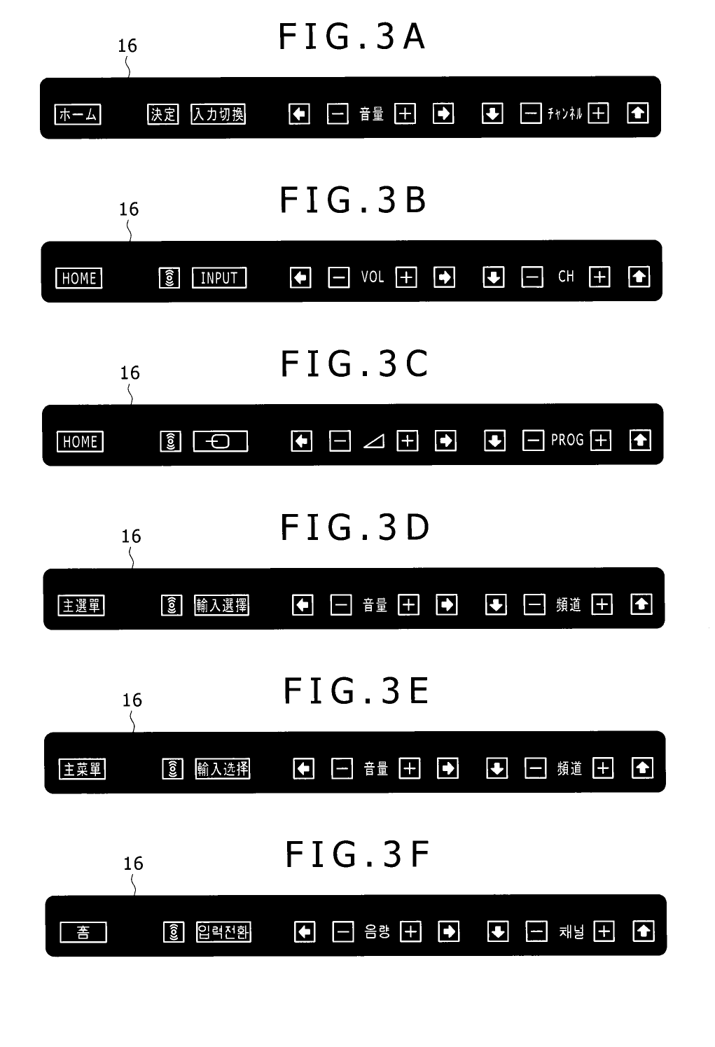

As shown in FIGS. 3A to 3F, the display portion 16A is composed of symbols of “+” and “−” for input switching and manipulation for increasing/decreasing a volume, symbols of “+” and “−” for manipulation for channel switching, and the like.

FIGS. 3A to 3F are respectively top plan views of the printed members 16, and thus show examples of the printed members 16.

A plurality of printed members 16, as shown in FIGS. 3A, 3B, 3D, 3E and 3F, are prepared so as to correspond to languages such as Japanese, English, Chinese and Korean, respectively.

Or, a plurality of printed members 16, as shown in FIGS. 3B and 3C, are prepared so as to correspond to display contents, respectively, although they have the same language.

The printed member 16 is bonded to the back surface 1404 of the display plate 14 so as to overlap the back surface 1404 of the display plate 14 by using an adhesive agent or a double-stick tape.

In a state in which the printed member 16 is disposed on the back surface 1404 of the display plate 14, the display portion 16A, the first smoke printed layer 22 and the second smoke printed layer 26 are disposed in respective portions agreeing with one another in the thickness direction of the display plate 14.

The light guiding member 18 is a plate-like member made of a synthetic resin material adapted to transmit a light to diffuse the light.

One surface in a thickness direction of the light guiding member 18 is structured as a light emission surface 18A having an outline having such a size as to cover the entire display portion 16A of the printed member 16. Also, an end surface of the light guiding member 18 intersecting with the light emission surface 18A is structured as a light introduction surface 18B for introducing a light.

The light guiding member 18 is disposed so as to hold the printed member 16 between the display plate 14 and the light guiding member 18 in a way that the light emission surface 18A is made to face the backward of the back surface 1404 of the display plate 14. Therefore, the light emission surface 18A faces the back surface of the printed member 16.

The light emitting portion 20 radiates a light to the light introduction surface 18B of the light guiding member 18. The common knowledge of past various kinds of light sources such as a light emitting diode can be adopted as the light emitting portion 20.

A light which has been introduced from the light emitting portion 20 into the inside of the light guiding member 18 through the light introduction surface 18B is radiated from the light emission surface 18A to the printed member 16.

In the first embodiment, a radiating portion for radiating a light from a portion on a side opposite to the display plate 14 with respect to the printed member 16 to the display portion 16A is composed of the light guiding member 18 and the light emitting portion 20.

The touch switch 12 is composed of a substrate 12A, and touch sensors 12B formed on a front surface of the substrate 12A.

The touch switch 12 is disposed in a way that the touch sensors 12B are made to face the back surface 1404 of the display plate 14.

The touch sensors 12B are disposed in portions, for example, corresponding to the symbols of “+” and “−” for the input switching and the manipulation for increasing/decreasing the volume, the symbols of “+” and “−” for the manipulation for the channel switching, and the like of the display portion 16A.

The touch sensor 12B serves to detect a fingertip touching the surface 1402 of the display plate 14 to generate a detection signal, and to supply the detection signal thus generated to a control portion (not shown) of the television set 2.

The common knowledge of past various kinds of sensors such as an electrostatic capacitance type touch sensor can be adopted as each of the touch sensors 12B.

Next, an operation will be described.

When a power source of the television set 2 is turned ON, the control portion of the television set 2 instructs the light emitting portion 20 to emit a light.

As a result, the light emitted through the light emission surface 18A of the light guiding member 18 is radiated to the back surface of the printed member 16. The light transmitted through the display portion 16A reaches the surface 1402 of the display plate 14 through the second smoke printed layer 26, the light transmissive area 24A, and the first smoke printed layer 22. As a result, the display portion 16A is visually recognized in a bright state. In other words, the display portion 16A (characters) is displayed just as if it is floated.

When the front surface 1402 of the display plate 14 is touched with a fingertip in this state, the fingertip is detected by corresponding one of the touch sensors 12B. As a result, the control portion of the television set 2 carries out a predetermined operation such as channel selection or adjustment of the volume in accordance with the detection signal supplied from the corresponding one of the touch sensors 12B.

On the other hand, when the power source of the television set 2 is turned OFF, the control portion of the television set 2 instructs the light emitting portion 20 to stop the light emission.

As a result, since no light is radiated from the light emitting portion 20, the display portion 16A of the printed member 16 cannot be visually recognized when viewed from the front surface 1402 of the display plate 14 by the operations of the two smoke printed layers of the first and second smoke printed layers 22 and 26.

In addition, the first smoke printed layer 22 is solid-printed over the entire area of the back surface 1404 of the display plate 14. Thus, since a boundary between the masking layer 24 and the light transmissive area 24A is masked, the entire front surface 1402 of the display plate 14 can be visually recognized as having a uniform exterior appearance when viewed from the surface 1402 of the display plate 14.

In addition, the exterior appearance property is ensured irrespective of emission and non-emission of the light from the light emitting portion 20 because the parts or components, or the members located in the backward of the masking layer 24 are masked by the masking layer 24.

According to the first embodiment of the present invention, since the display plate 14 and the printed member 16 are structured separately from each other, as shown in FIGS. 3A to 3F, a plurality kind of display devices 10 can be simply structured by carrying out the very simple work that a plurality kind of printed members 16 are previously prepared so as to correspond to the destinations or specifications, respectively, and the printed member 16 selected from the plurality kind of printed members, and the display plate 14 are combined with each other.

Therefore, the first embodiment is advantageous in reducing the manufacture cost as compared with the case where a plurality kind of display devices are previously prepared so as to correspond to the destinations or specifications, respectively.

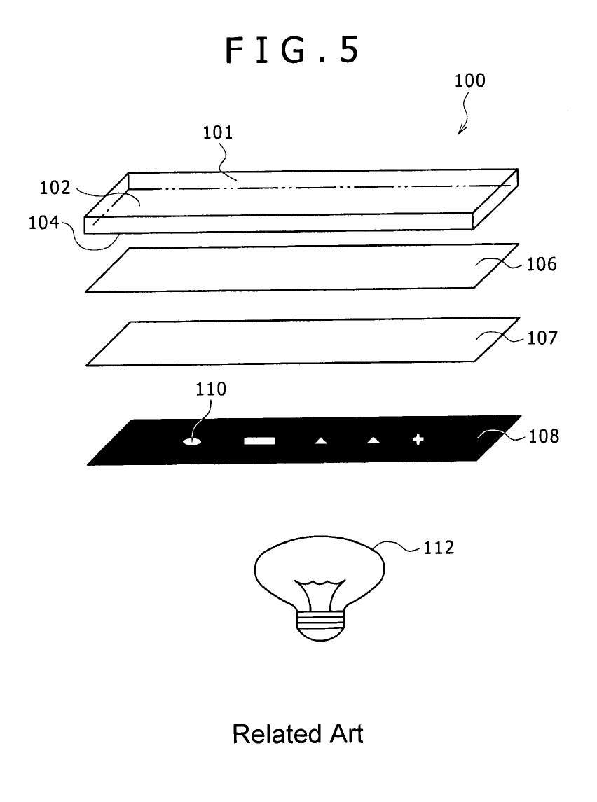

That is to say, as shown in FIG. 5, heretofore, in a display device 100, a first smoke printed layer 106 and a second smoke printed layer 107 are formed in this order on a back surface 104 of a display plate 102.

Also, a black ink adapted to transmit no light is solid-printed on a back surface of the second smoke printed layer 107, thereby forming a printed layer 108 for a display portion integrally with the display plate 102.

That is to say, the display portion 110 for characters, symbols, frame lines, patterns, or the like which is composed of a portion having no ink printed thereon is formed in the printed layer 108 for the display portion. Also, an ink is printed over the entire area except for the display portion 110.

On the other hand, in the existing display device 100, a light is radiated from a backward of the display plate 102 by a light source 112 to brighten the display portion 110, thereby visually recognizing characters, symbols, frame lines, patterns, or the like in the display portion 110 from the front surface 101 side of the display plate 102.

Therefore, heretofore, a plurality kind of display devices 100 having the contents, displayed on the display portions 110, which are different from one another so as to correspond to the destinations or the specifications, respectively, must be prepared in advance because the printed layer 108 for the display portion is directly formed integrally with the display plate 102. Thus, there is the disadvantage that the manufacture cost increases. On the other hand, the first embodiment is advantageous in largely reducing the manufacture cost.

In addition, in a state in which the light emitting portion 20 emits no light, and thus the display portion 16A is not bright, the display portion 16A of the printed member 16 becomes unnoticeable due to the operations of the two smoke printed layers, i.e., the first and second smoke printed layers 22 and 26. Therefore, the uniform exterior appearance is obtained over the entire front surface 1402 of the display plate 14, and thus is visually recognized just as if there is no printed member 161.

Therefore, the first embodiment is advantageous in enhancing the exterior appearance property and design property of the display device 10.

### Second Embodiment

Next, a second embodiment of the present invention will be described.

In the first embodiment, in the state in which the display portion 16A is not bright, the display portion 16A is not visually recognized due to the operations of the first and second smoke printed layers 22 and 26. On the other hand, the second embodiment is different from the first embodiment in that in the state in which the display portion 16A is not bright, the display portion 16A is prevented from being visually recognized due to an operation of a pearl ink printed layer 32.

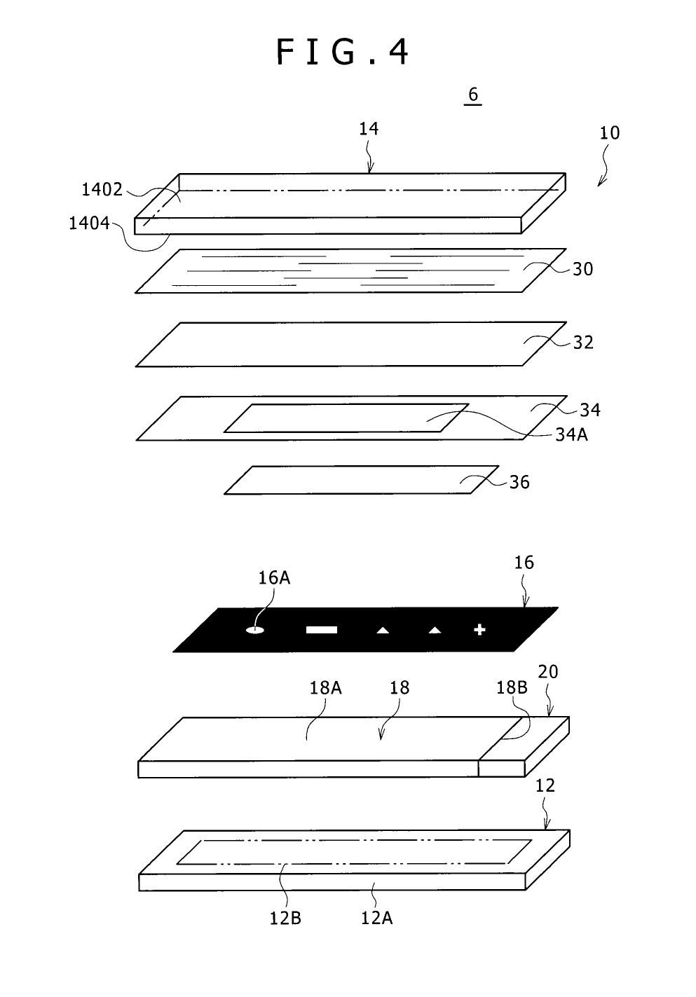

FIG. 4 is an exploded perspective view of a manipulation section 6 using a display device 10 according to the second embodiment of the present invention.

It is noted that hereinafter, portions and members identical to or corresponding to those in the first embodiment are designated with the same reference numerals, respectively, and a description thereof is given in brief.

As shown in FIG. 4, a manipulation section 6 is composed of a display device 10 according to the second embodiment of the present invention, a touch switch 12, and the like similarly to the case of the first embodiment. Also, the display device 10 includes a display plate 14, a printed member 16, a light guiding member 18, a light emitting portion 20, and the like.

The display plate 14 is made of a transparent material through which a light can be transmitted, and has a plate-like shape similarly to the case of the first embodiment. The display plate 14 has a front surface 1402, and a back surface 1404 located on the side opposite to the front surface 1402.

A hairline printed layer 30, a pearl ink printed layer 32, a masking layer 34, and a smoke printed layer 36 are formed in this order on the back surface 1404 of the display plate 14.

For formation of the hairline printed layer 30, hairlines are printed over the entire area of the back surface 1404 of the display plate 14 by using a medium adapted to transmit a light. In other words, an irregular shape expressing the hairlines is formed over the entire area of the back surface 1404 of the display plate 14 by carrying out medium printing.

The pearl ink printed layer 32 is formed by solid-printing a pearl ink over the entire area of a surface of the hairline printed layer 30 opposite to a surface of the hairline printed layer 30 facing the back surface 1404 of the display plate 14. In this case, the pearl ink printed layer 32 is structured so as to be either light-transmissive or light-semi-transmissive.

In other words, the pearl ink printed layer 32 is formed on the hairline printed layer 30, and thus the pearl ink printed layer 32 is provided on the back surface 1404 of the display plate 14 through the hairline printed layer 30.

The pearl ink is an ink which is obtained by adding an inorganic pigment called a pearl pigment to a transparent medium. When receiving an outside light, a portion printed with the pearl ink reflects the outside light with a color tone like a pearl. In other words, this portion printed with the pearl ink is visually recognized to have the metallic-tone exterior appearance.

In addition, since various kinds of color tones can be obtained by adjusting a composition of the pearl ink, a color variation of the metallic-tone exterior appearance is arbitrarily set.

The pearl ink printed layer 32 is formed on the surface of the hairline printed layer 30 on the side opposite to the surface of the hairline printed layer 30 facing the ink surface 1404 of the display plate 14. As a result, as will be descried later, when a light transmitted through the display portion 16A is radiated from the backward of the display plate 14 to the back surface 1404 thereof, the light is absorbed in the pearl ink printed layer 32 to a certain extent, and the remaining light is transmitted through the smoke printed layer 36 to reach the front side of the front surface 1402 of the display plate 14, thereby being visually recognized by the user.

On the other hand, when no light is radiated from the backward of the display plate 14 to the back surface 1404 thereof, if the outside light is radiated from the front side of the display plate 14 to the front surface 1402 thereof, the outside light is reflected by the pearl ink layer 32 to obtain the metallic-tone exterior appearance. As a result, the members, or the parts or components provided in the backward of the pearl ink printed layer 32 cannot be visually recognized through the pearl ink printed layer 32.

The masking layer 34 is made of a material adapted to transmit no light. Also, the masking layer 34 is formed on a part of a surface of the pearl ink printed layer 32 on a side opposite to a surface of the pearl ink printed layer 32 facing the hairline printed layer 30.

In the second embodiment, the mask layer 34 is formed by solid-printing a black ink as a material adapted to transmit no light.

Also, in the second embodiment, the mask layer 34 is formed into a rectangular frame-like shape. Therefore, a rectangular light transmissive area 34A, having no mask layer 34 formed therein, through which a light can be transmitted is formed inside the rectangular frame.

The smoke printed layer 36 is formed by solid-printing a smoke ink expressing dark semi-transparence on the light transmissive area 34A.

The smoke printed layer 36 is formed in the light transmissive area 34A, which results in that when as will be described later, a light transmitted through the display portion 16A is radiated from the backward of the display plate 14 to the back surface 1404 thereof, the light is absorbed in the smoke ink printed layer 36 to a certain extent, and the remaining light is transmitted through the smoke ink printed layer 36 to reach the front side from the front surface 1402 of the display plate 14, thereby being visually recognized by the user.

On the other hand, when no light is radiated from the backward of the display plate 14 to the back surface 1404 thereof, even if the outside light is radiated from the front side of the display plate 14 to the surface 1402 thereof, the outside light is absorbed by the smoke ink printed layer 36 because a quantity of outside light is limited.

Therefore, since the smoke printed layer 36 expresses a dark color, it is impossible to visually recognize any of the members, the parts or components provided in the backward of the smoke printed layer 36 through the smoke printed layer 36.

The printed member 16 is structured similarly to the case of the first embodiment. Thus, the printed member 16 is bonded to the back surface 1404 of the display plate 14 so as to overlap the back surface 1404 of the display plate 14 by using an adhesive agent or a double-stick tape.

In a state in which the printed member 16 is disposed on the back surface 1404 of the display plate 14, the display portion 16A, the light transmissive are 34A, and the smoke printed layer 36 are disposed in respective portions agreeing with one another in the thickness direction of the display plate 14.

In addition, a radiating portion composed of a light guiding member 18 and a light emitting portion 20, and a touch switch 12 are respectively structured similarly to those in the first embodiment.

Next, an operation will be described.

When a power source of the television set 2 is turned ON, the control portion of the television set 2 instructs the light emitting portion 20 to emit a light.

As a result, the light emitted through the light emission surface 18A of the light guiding member 18 is radiated to the back surface of the printed member 16. The light transmitted through the display portion 16A reaches the front surface 1402 of the display plate 14 through the smoke printed layer 36, the light transmissive area 34A, the pearl ink printed layer 32, and the hairline printed layer 30. As a result, the display portion 16A is visually recognized in a bright state. In other words, the display portion 16A (characters) is displayed just as if transmission type characters are floated.

When the front surface 1402 of the display plate 14 is touched with the fingertip in this state, the fingertip is detected by corresponding one of the touch sensors 12B. As a result, the control portion of the television set 2 carries out a predetermined operation such as channel selection or adjustment of the volume in accordance with the detection signal supplied from the corresponding one of the touch sensors 12B.

On the other hand, when the power source of the television set 2 is turned OFF, the control portion of the television set 2 instructs the light emitting portion 20 to stop the light emission.

As a result, since no light is radiated from the light emitting portion 20, the display portion 16A of the printed member 16 cannot be visually recognized when viewed from the front surface 1402 of the display plate 14 due to the operations of the three printed layers of the hairline printed layer 30, the pearl ink printed layer 32, and the smoke printed layer 36.

In addition, the pearl ink layer 32 is solid-printed over the entire area of the back surface 1404 of the display plate 14 through the hairline printed layer 30. Thus, since a boundary between the masking layer 34 and the light transmissive area 34A is masked when viewed from the front surface 1402 of the display plate 14, the boundary cannot be visually recognized.

That is to say, the visual recognition is made in the state in which the three printed layers of the hairline printed layer 30, the pearl ink printed layer 32, and the mask printed layer 36 overlap one another. Also, the boundary between the masking layer 34 and the light transmissive area 34A is masked by the operation of the pearl ink printed layer 32. As a result, the front surface 1402 of the display plate 14 has the exterior appearance in which the uniform metallic-tone hairlines are formed over the entire front surface 1402, and thus the entire front surface 1402 of the display plate 14 is visually recognized just as if there is no printed member 16.

In addition, the exterior appearance property is ensured irrespective of emission and non-emission of the light from the light emitting portion 20 because the parts or components, or the members located in the backward of the mask layer 34 are masked by the mask layer 34.

According to the second embodiment of the present invention, the same operations and effects as those of the first embodiment are offered.

In addition, the exterior appearance having the metallic-tone hairlines can be advantageously obtained with the inexpensive structure in which the three printed layers of the hairline printed layer 30, the pearl ink printed layer 32, and the mask printed layer 36 are printed on the back surface 1404 of the display plate 14.

In particular, although a thin metallic film is formed on the back surface 1402 of the display plate 14 by carrying out the vacuum evaporation, which results in that it is possible to obtain an effect that the thin metallic film has a light transmissive or light semi-transmissive property, a manufacture method using the vacuum evaporation has a disadvantage that the manufacture cost increases. On the other hand, the second embodiment is advantageous in reducing the manufacture cost.

In addition, heretofore, when a metallic ink or a mirror ink used to obtained the metallic-tone exterior appearance is printed on the back surface 1404 of the display plate 14, such an ink hardly transmits a light because it contains therein metallic fine powders, and thus it is difficult to give the display plate 14 a light transmissive or light semi-transmissive function. However, in the second embodiment, the display plate 14 can be given the light transmissive or light semi-transmissive function with the simple structure in which the three printed layers of the hairline printed layer 30, the pearl ink printed layer 32, and the mask printed layer 36 are printed on the back surface 1404 of the display plate 14.

It is noted that although in the second embodiment, the display plate 14 expresses the exterior appearance having the metallic hairlines by forming the hairline printed layer 30, the hairline printed layer 30 may be omitted. In this case, the display plate 14 expresses the uniform metallic-tone exterior appearance.

However, when the hairline printed layer 30 is formed as in the case of the second embodiment, the texture of the exterior appearance of the display plate 14 can be further enhanced, which is more advantageous in giving a feeling of quality to the display plate 14.

Note that, in the second embodiment, the description has been given so far with respect to the case where the printed member 16 is formed by printing the ink adapted to transmit no light on the transparent sheet structured separately from the display plate 14. However, a structure may also be adopted such that a printed member is formed on the surface of the smoke printed layer 36 on the side opposite to the surface of the smoke printed layer 36 facing the light transmissive area 34A, and thus is provided on the back surface 1404 of the display plate 14 through the smoke printed layer 36.

In this case, the display plate 14 and the printed member are structured integrally with each other. However, in a state in which the display portion 16A is not bright because the light emitting portion 20 emits no light, the entire area of the surface 1402 of the display plate 14 expresses the uniform metallic-tone exterior appearance, and thus the uniform metallic-tone exterior appearance is visually recognized just as if there is no printed member 16. Therefore, this is advantageous in enhancing the exterior appearance property and design property of the display device 10.

In addition, an influence (attenuation) exerted on an infrared signal while the infrared signal is transmitted through the first and second smoke printed layers 22 and 26 formed on the display plate 14 in the first embodiment, or the hairline printed layer 30, the pearl ink printed layer 32 and the smoke printed layer 36 formed on the display plate 14 in the second embodiment is negligible small.

Therefore, it is of course possible to dispose a light receiving portion for receiving an infrared signal transmitted from an infrared remote controller in the backward of the display plate 14 in the first and second embodiments.

In addition, although in the first and second embodiments, the description has been given so far with respect to the case where the display device 10 configures the manipulation section 6 together with the touch switch 12, the present invention is by no means limited thereto. That is to say, the embodiments of the present invention can be of course applied to the case where the display device 10 configures no manipulation section 6, but configures an indicator or the like for carrying out only display using the display portion 16A.

In addition, although in the first and second embodiments, the description has been given so far with respect to the case where the display device 10 is applied to the television set 2, the present invention is by no means limited thereto. That is to say, the embodiments of the present invention can be of course generally used in various kinds of electronic apparatuses.

It should be understood by those skilled in the art that various modifications, combinations, sub-combinations and alterations may occur depending on design requirements and other factors insofar as they are within the scope of the appended claims or the equivalents thereof.

What is claimed is:

1. A display device, comprising:
a transparent display plate having a front surface and a back surface, the display plate including:
a pearl ink layer disposed on the back surface of the display plate, the pearl ink layer being semi-light-transmissive;
a masking layer disposed on a side of the pearl ink layer opposite the back surface of the display plate, the masking layer having a first portion that is not light-transmissive and a second portion that is light-transmissive; and
a smoke ink layer disposed on a side of the masking layer opposite the back surface of the display plate, the smoke ink layer being semi-transparent;
a substrate having one or more light-transmissive areas in a shape of a symbol, a character or a pattern;
an adhesive layer that adheres the substrate to the back surface of the display plate; and
a radiating portion, disposed on a side of the substrate opposite the adhesive layer, that radiates light towards the one or more light-transmissive areas of the substrate, wherein
the adhesive layer adheres the substrate to a surface of the smoke ink layer on a side opposite a surface of the smoke ink layer facing the masking layer and to the back surface of the display plate through the smoke ink layer.

2. The display device according to claim 1, wherein
the display plate further includes:
a hairline layer including an irregular shape expressing a hairline disposed on the back surface of the display plate, wherein
the pearl ink layer is disposed on the hairline layer, and
the pearl ink layer is disposed on the back surface of the display plate through the hairline layer.

3. The display device of claim 2, wherein the hairline layer increases the light-transmissivity of the display plate.

4. The display device according to claim 1, wherein the substrate includes a non-light-transmissive ink disposed on a transparent sheet.

5. The display device according to claim 1, wherein the substrate is plastic.

6. The display device according to claim 1, wherein the first portion of the masking layer surrounds the second portion of the masking layer.

7. The display device according to claim 1, wherein,
the first portion of the masking layer is formed from ink, and
the second portion of the masking layer is an opening in the masking layer where no ink is disposed.

8. A display device, comprising:
a transparent display plate having a front surface and a back surface, the display plate including:
a first smoke ink layer disposed on the back surface of the display plate, the first smoke ink layer being semi-transparent;
a masking layer disposed on a side of the first smoke ink layer opposite the back surface of the display plate, the masking layer having a first portion that is not light-transmissive and a second portion that is light-transmissive; and
a second smoke ink layer disposed on a side of the masking layer opposite the back surface of the display plate, the second smoke ink layer being semi-transparent;
a substrate having one or more light-transmissive areas in the shape of a symbol, a character or a pattern;
an adhesive layer that adheres the substrate to the back surface of the display plate; and
a radiating portion, disposed on a side of the substrate opposite the adhesive layer, that radiates light towards the one or more light-transmissive areas of the substrate, wherein
the adhesive layer adheres the substrate to a surface of the second smoke ink layer on a side opposite a surface of the second smoke ink layer facing the masking layer and to the back surface of the display plate through the second smoke ink layer.

9. The display device according to claim 8, wherein the substrate is plastic.

10. The display device according to claim 8, wherein the first portion of the masking layer surrounds the second portion of the masking layer.

11. The display device according to claim 8, wherein,
the first portion of the masking layer is formed from ink, and
the second portion of the masking layer is an opening in the masking layer where no ink is disposed.
